(19) United States
(12) Patent Application Publication
(10) Pub. No.: US 2016/0379246 A1
(43) Pub. Date: Dec. 29, 2016

(54) METHODS AND APPARATUS TO ESTIMATE AN UNKNOWN AUDIENCE SIZE FROM RECORDED DEMOGRAPHIC IMPRESSIONS

(71) Applicant: The Nielsen Company (US), LLC, New York, NY (US)

(72) Inventors: Michael Sheppard, Brooklyn, NY (US); Jonathan Sullivan, Natick, MA (US); Peter Lipa, Tucson, AZ (US); Matthew B. Reid, Alameda, CA (US); Alejandro Terrazas, Santa Cruz, CA (US)

(21) Appl. No.: 14/752,441

(22) Filed: Jun. 26, 2015

(51) Int. Cl. G06Q 30/02

(52) U.S. Cl. CPC G06Q 30/0246

(57) ABSTRACT

Methods, apparatus, systems and articles of manufacture are disclosed to estimate an unknown audience size from recorded impressions for an online media. The estimate of the unknown audience size for the online media is based on a total number of initial impressions and a frequency distribution of recorded demographic impressions across a partial audience size for the online media. The estimate of the unknown audience size is determined by modeling the probability of obtaining the frequency distribution of the recorded demographic impressions across the partial audience for different possible unknown audience sizes in a range of unknown audience sizes and determining an estimate for the unknown audience size by evaluating the models for the different possible unknown audience sizes.

### FIELD OF THE DISCLOSURE

This disclosure relates generally to monitoring media, and, more particularly, to estimating an unknown audience size from recorded demographic impressions.

### BACKGROUND

Traditionally, audience measurement entities determined audience engagement levels for media based on registered panel members. That is, an audience measurement entity (AME) enrolled people who consented to being monitored into a panel. The AME then monitored those panel members to determine media (e.g., television programs, radio programs, movies, DVDs, advertisements, streaming media, websites, etc.) presented to those panel members. In this manner, the AME could determine exposure metrics for different media based on the collected media measurement data.

Techniques for monitoring user access to Internet resources, such as web pages, advertisements and/or other Internet-accessible media, have evolved significantly over the years. Internet-accessible media is also known as online media. Some known systems perform such monitoring primarily through server logs. In particular, entities serving media on the Internet can use known techniques to log the number of requests received at their server for their media (e.g., content and/or advertisements).

### BRIEF DESCRIPTION OF THE DRAWINGS

FIG. 1 illustrates example client devices that report audience impressions for Internet-based media to impression collection entities to facilitate identifying total initial impressions and sizes of audiences exposed to different Internet-based media.

FIG. 2 illustrates an example communication flow diagram of a manner in which an example audience measurement entity (AME), including an example audience estimator, and an example database proprietor (DP) can collect impressions that allow the audience estimator to estimate the size of an unknown audience.

FIG. 3 is an example plot showing an estimation of an unknown audience size.

FIG. 4 is a flowchart representative of example machine readable instructions for implementing the example audience estimator of FIGS. 1 & 2.

FIG. 5 is a block diagram of an example processor platform 500 structured to execute the instructions of FIG. 4 to implement the example audience estimator of FIGS. 1 & 2.

The figures are not to scale. Wherever possible, the same reference numbers will be used throughout the drawing(s) and accompanying written description to refer to the same or like parts.

### DETAILED DESCRIPTION

Techniques for monitoring user access to Internet-accessible media, such as web pages, advertisements, content and/or other media, have evolved significantly over the years. Internet-accessible media is also known as online media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server side log monitoring techniques described above. For example, Blumenau disclosed a technique wherein Internet media to be tracked is tagged with beacon instructions. In particular, monitoring instructions (also known as a beacon) are associated with the hypertext markup language (HTML) of the media to be tracked. When a client requests the media, both the media and the beacon instructions are downloaded to the client. The beacon instructions are, thus, executed whenever the media is accessed, be it from a server or from a cache.

The beacon instructions cause monitoring data reflecting information about the access to the media to be sent from the client that downloaded the media to a monitoring entity. Sending the monitoring data from the client to the monitoring entity is known as a beacon request. Typically, the monitoring entity is an AME that did not provide the media to the client and who is a trusted (e.g., neutral) third party for providing accurate usage statistics (e.g., The Nielsen Company, LLC). Advantageously, because the beaconing instructions are associated with the media and executed by the client browser whenever the media is accessed, the monitoring information is provided to the AME (e.g. via a beacon request) irrespective of whether the client is a panelist of the AME.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, etc.), etc. These database proprietors set cookies and/or other device/user identifiers on the client devices of their subscribers to enable the database proprietor to recognize their subscribers when they visit their website.

The protocols of the Internet make cookies inaccessible outside of the domain (e.g., Internet domain, domain name, etc.) on which they were set. Thus, a cookie set in, for example, the amazon.com domain is accessible to servers in the amazon.com domain, but not to servers outside that domain. Therefore, although an AME might find it advantageous to access the cookies set by the database proprietors, they are unable to do so.

The inventions disclosed in Mainak et al., U.S. Pat. No. 8,370,489, which is incorporated by reference herein in its entirety, enable an AME to leverage the existing databases of database proprietors to collect more extensive Internet usage by extending the beaconing process to encompass partnered database proprietors and by using such partners as interim data collectors. The inventions disclosed in Mainak et al. accomplish this task by structuring the AME to respond to beacon requests from clients (who may not be a member of an audience member panel and, thus, may be unknown to the audience member entity) by redirecting the clients from the AME to a database proprietor, such as a social network site partnered with the audience member entity, using a beacon response. Such a redirection initiates a communication session between the client accessing the tagged media and the database proprietor. For example, the beacon response received from the AME may cause the client to send a second beacon request to the database proprietor. In response to receiving this beacon request, the database proprietor (e.g., Facebook) can access any cookie it has set on the client to thereby identify the client based on the internal records of the database proprietor. In the event the client corresponds to a subscriber of the database proprietor, the database proprietor logs/records a demographic impression in association with the client/user and subsequently forwards logged demographic impressions to the audience measurement company.

As used herein, an impression is defined to be an event in which a home or individual accesses and/or is exposed to corresponding media (e.g., content and/or an advertisement). Thus, an impression represents a home or an individual having been exposed to media (e.g., an advertisement, content, a group of advertisements and/or a collection of content). In Internet advertising, a quantity of impressions or impression count is the total number of times media (e.g., content, an advertisement or advertisement campaign) has been accessed by a web population (e.g., the number of times the media is accessed). As used herein, an initial impression is an impression recorded by an impression collection entity (for example an AME or a database proprietor) in response to a beacon request from a client that requested the media. As used herein, a demographic impression is an impression recorded in a database proprietor in response to a beacon request from a registered user/client of the database proprietor.

In the event the client does not correspond to a subscriber of the database proprietor, the database proprietor may redirect the client to the AME and/or another database proprietor. The AME may respond to the redirection from the first database proprietor by redirecting the client to a second, different database proprietor that is partnered with the AME. That second database proprietor may then attempt to identify the client as explained above. This process of redirecting the client from database proprietor to database proprietor can be performed any number of times until the client is identified and the media exposure logged, or until all database partners have been contacted without a successful identification of the client. In some examples, the redirections occur automatically so the user of the client is not involved in the various communication sessions and may not even know they are occurring.

Periodically or aperiodically, the partnered database proprietors provide their logs and demographic information to the AME, which then compiles the collected data into statistical reports identifying audience members for the media.

Example techniques disclosed herein use database proprietors to identify demographic impressions in response to beacon requests associated with users to track quantities of impressions attributable to those users. In some examples, the demographic impressions collected by a database proprietor (e.g., Facebook, Yahoo, Google, etc.) may be inaccurate and/or incomplete when the database proprietor does not have complete coverage of device/user identifiers (e.g., cookies) at all of the client devices associated with beacon requests or, more generally associated with an impression to be logged. As used herein in this context, coverage represents the extent to which a database proprietor has set cookies or, more generally, device/user identifiers in client devices associated with beacon requests. For example, if only 50% of client devices that send a beacon request associated with a media impression to the database proprietor have a cookie set therein by the database proprietor, then the database proprietor has 50% coverage of such client devices. A client device may not have a cookie set by the database proprietor in its web browser if, for example, a user doesn't have an account with the database proprietor or if the user has an account with the database proprietor but has cleared the cookie cache and deleted the database proprietor's cookie before or at the time of a media exposure. In such examples, the database proprietor would not be able to identify the user associated with one or more media impressions and, thus, would not report any audience or demographic impressions for those impressions.

Example methods, apparatus and computer readable instructions to estimate an unknown audience size from recorded demographic impressions are disclosed herein. In some examples, estimates of the unknown audience size are created from demographic impression data collected by database proprietors. In some disclosed examples, an AME estimates an unknown audience size using a number of initial impressions, a number of recorded demographic impressions, a frequency distribution of the recorded demographic impressions across a partial audience and the number of people associated with the demographic impressions (e.g. the partial audience). The number of recorded demographic impressions and the partial audience size can be determined from the frequency distribution of the recorded demographic impressions.

The people associated with the demographic impressions at the database proprietor are referred to as the partial audience. The term partial audience is used because some individuals associated with the initial impressions sent to the AME, may not be registered with the database proprietor. As such, the database proprietor will not record demographic impressions for these individuals in response to redirected beacon requests because these individuals are not register with the database proprietor.

In some disclosed examples, a list of initial impressions for a given online media is sent to one or more database proprietor(s). The database proprietor(s) respond with a number of recorded demographic impressions and a frequency distribution of the recorded demographic impressions across the partial audience. In other examples, the database proprietor may receive initial impressions for media from users. The database proprietor may record the number of initial impressions as well as demographic impressions for each initial impression that is from a device registered with the database proprietor. In these other examples, the database proprietor will provide the total number of initial impressions and the frequency distribution of the recorded demographic impressions across the partial audience to the AME.

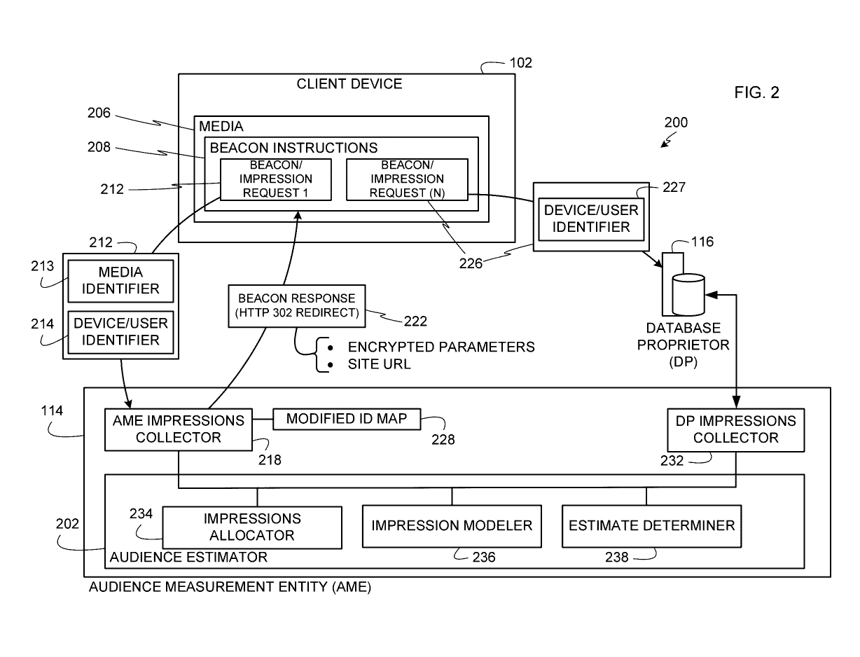

In some disclosed examples, the demographic impressions are collected by an AME responding to beacon requests from client devices by redirecting the client devices to communicate with the database proprietor to enable the database proprietor to record the demographic impressions. In some such examples, the client devices are instructed to provide an identifier (e.g., a device/user identifier 227 of FIG. 2) to the database proprietor. In such examples, the identifier does not identify the media or a source of the media.

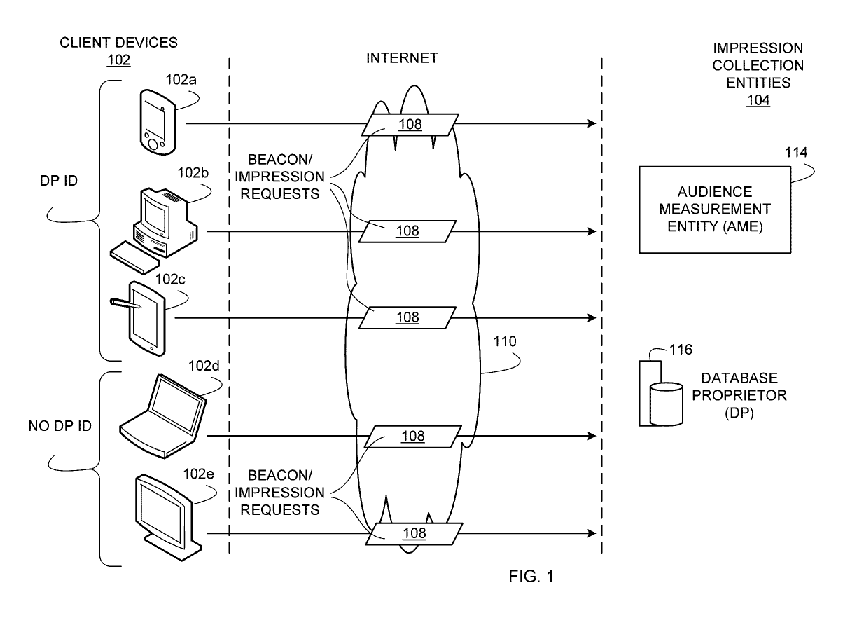

FIG. 1 illustrates example client devices 102 that report audience impressions for Internet-based media to impression collection entities 104 to facilitate identifying total impressions and sizes of audiences exposed to different Internet-based media. As used herein, the term impression collection entity refers to any entity that collects impression data such as, for example, AMEs and database proprietors that collect impression data. The client devices 102 of the illustrated example may be any device capable of accessing media over a network. For example, the client devices 102 may be a computer, a tablet, a mobile device, a smart television, or any other Internet-capable device or appliance. Examples disclosed herein may be used to collect impression information for any type of media including content and/or advertisements. Media may include advertising and/or content delivered via web pages, streaming video, streaming audio, Internet protocol television (IPTV), movies, television, radio and/or any other vehicle for delivering media. In some examples, media includes user-generated media that is, for example, uploaded to media upload sites, such as YouTube, and subsequently downloaded and/or streamed by one or more other client devices for playback. Media may also include advertisements. Advertisements are typically distributed with content (e.g., programming). Traditionally, content is provided at little or no cost to the audience because it is subsidized by advertisers that pay to have their advertisements distributed with the content. As used herein, “media” refers collectively and/or individually to content and/or advertisement(s).

In the illustrated example, the client devices 102 employ web browsers and/or applications (e.g., apps) to access media, some of which include instructions (e.g. the media is tagged) that cause the client devices 102 to report media monitoring information to one or more of the impression collection entities 104. That is, when a client device 102 of the illustrated example accesses media, a web browser and/or application of the client device 102 executes instructions in the media to send a beacon request or impression request 108 to one or more impression collection entities 104 via, for example, the Internet 110. The beacon requests 108 of the illustrated example include information about accesses to media at the corresponding client devices 102 generating the beacon requests. Such beacon requests allow monitoring entities, such as the impression collection entities 104, to collect initial impressions for different media accessed via the client devices 102. In this manner, the impression collection entities 104 can generate initial impression quantities for different media (e.g., different content and/or advertisement campaigns).

The impression collection entities 104 of the illustrated example include an example AME 114 and an example database proprietor (DP) 116. In the illustrated example, the AME 114 does not provide the media to the client devices 102 and is a trusted (e.g., neutral) third party (e.g., The Nielsen Company, LLC) for providing accurate media access statistics. In the illustrated example, the database proprietor 116 is one of many database proprietors that operates on the Internet to provide services to subscribers. Such services may be email services, social networking services, news media services, cloud storage services, streaming music services, streaming video services, online retail shopping services, credit monitoring services, etc. Example database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, etc.), and/or any other site that maintains user registration records.

In examples disclosed herein, the database proprietor 116 maintains user account records corresponding to users registered for services (such as Internet-based services) provided by the database proprietors. That is, in exchange for the provision of services, subscribers register with the database proprietor 116. As part of this registration, the subscribers provide detailed demographic information to the database proprietor 116. Demographic information may include, for example, gender, age, ethnicity, income, home location, education level, occupation, etc. In the illustrated example, the database proprietor 116 sets a device/user identifier (e.g., an identifier described below in connection with FIG. 2) on a subscriber's client device 102 that enables the database proprietor 116 to identify the subscriber.

In the illustrated example, when the database proprietor 116 receives a beacon/impression request 108 from a client device 102, the database proprietor 116 requests the client device 102 to provide the device/user identifier that the database proprietor 116 had previously set for the client device 102. The database proprietor 116 uses the device/user identifier corresponding to the client device 102 to identify the subscriber of the client device 102.

In the illustrated example, three of the client devices 102a, 102b, and 102c have DP IDs (DP device/user IDs) that identify corresponding subscribers of the database proprietor 116. In this manner, when the client devices 102a, 102b, 102c corresponding to DP subscribers send beacon requests 108 to the impression collection entities 104, the database proprietor 116 can record demographic impressions for the user. (Although for simplicity of illustration, the signaling is not shown in FIG. 1, it is understood that the client devices 102a, 102b, 102c (and/or any other client device) may communicate with the AME 114 and/or the database proprietor 116 using the redirection mechanism disclosed in Mainak et al., U.S. Pat. No. 8,370,489, as described above.) In the illustrated example, the client devices 102d, 102e do not have DP IDs. As such, the database proprietor 116 is unable to identify the client devices 102d, 102e due to those client devices not having DP IDs set by the database proprietor 116. The client devices 102d, 102e may not have DP IDs set by the database proprietor 116 if, for example, the client devices 102d, 102e do not accept cookies, a user doesn't have an account with the database proprietor 116 or the user has an account with the database proprietor 116 but has cleared the DP ID (e.g., cleared a cookie cache) and deleted the database proprietor's DP ID before or at the time of a media exposure. In such instances, if the user device 102 is, for example, redirected to contact the database proprietor 116 using the system disclosed in Mainak et al., U.S. Pat. No. 8,370,489, the database proprietor 116 is not able to detect demographics corresponding to the media exposure and, thus, does not report/log any audience or demographic impressions for that exposure. In examples disclosed herein, the client devices 102d, 102e are referred to herein as client devices over which the database proprietor 116 has non-coverage because the database proprietor 116 is unable to identify demographics corresponding to those client devices 102d, 102e. As a result of the non-coverage, the database proprietor 116 underestimates the audience size and number of impressions for corresponding media accessed via the client devices 102 when, for example, operating within the system of Mainak et al., U.S. Pat. No. 8,370,489.

FIG. 2 is an example communication flow diagram 200 of an example manner in which the AME 114 and the DP 116 can collect recorded demographic impressions based on client devices 102 reporting impressions to the AME 114 and the DP 116. FIG. 2 also shows an example audience estimator 202 to estimate an unknown audience size given a number of initial impressions, a number of demographic impression recorded by the DB 116, a frequency distribution of the number of demographic impression recorded by the DB 116 and a partial audience size associated with the demographic impressions recorded at the DB 116. The example chain of events shown in FIG. 2 occurs when a client device 102 accesses media for which the client device 102 reports an impression to the AME 114 and the database proprietor 116. In some examples, the client device 102 reports impressions for accessed media based on instructions (e.g., beacon instructions) embedded in the media that instruct the client device 102 (e.g., instruct a web browser or an app in the client device 102) to send beacon/impression requests (e.g., the beacon/impression requests 108 of FIG. 1) to the AME 114 and/or the database proprietor 116. In some such examples, the media having the beacon instructions is referred to as tagged media. In some examples, the client device 102 reports impressions for accessed media based on instructions embedded in apps or web browsers that execute on the client device 102 to send beacon/impression requests (e.g., the beacon/impression requests 108 of FIG. 1) to the AME 114 and/or the database proprietor 116 for corresponding media accessed via those apps or web browsers. In some examples, the beacon/impression requests (e.g., the beacon/impression requests 108 of FIG. 1) include device/user identifiers (e.g. DP IDs) as described further below to allow the corresponding database proprietor 116 log demographic impressions.

In the illustrated example, the example client device 102 accesses media 206 that is tagged with the example beacon instructions 208. The example beacon instructions 208 cause the example client device 102 to send an example beacon/impression request 212 to an example AME impressions collector 218 when the client device 102 accesses the media 206. For example, a web browser and/or app of the client device 102 executes the beacon instructions 208 in the media 206, which instruct the browser and/or app to generate and send the beacon/impression request 212. In the illustrated example, the client device 102 sends the beacon/impression request 212 using an HTTP (hypertext transfer protocol) request addressed to the URL (uniform resource locator) of the AME impressions collector 218 at, for example, a first Internet domain of the AME 114. The beacon/impression request 212 of the illustrated example includes an example media identifier 213 (e.g., an identifier that can be used to identify content, an advertisement, and/or any other media) corresponding to the media 206. In some examples, the beacon/impression request 212 also includes a site identifier (e.g., a URL) of the website that served the media 206 to the client device 102 and/or a host website ID (e.g., www.acme.com) of the website that displays or presents the media 206. In the illustrated example, the beacon/impression request 212 includes an example device/user identifier 214. In the some examples, the device/user identifier 214 that the client device 102 provides to the AME impressions collector 218 in the beacon impression request 212 may be an AME ID. This occurs when the device/user identifier corresponds to an identifier that the AME 114 uses to identify a panelist corresponding to the client device 102. In other examples, the client device 102 may not send the device/user identifier 214 until the client device 102 receives a request for the same from a server of the AME 114 in response to, for example, the AME impressions collector 218 receiving the beacon/impression request 212.

In some examples, the device/user identifier 214 may be a device identifier (e.g., an international mobile equipment identity (IMEI), a mobile equipment identifier (MEID), a media access control (MAC) address, etc.), a web browser unique identifier (e.g., a cookie), a user identifier (e.g., a user name, a login ID, etc.), an Adobe Flash® client identifier, identification information stored in an HTMLS datastore, and/or any other identifier that the AME 114 stores in association with the client devices 102. In this manner, when the AME 114 receives the device/user identifier 214, the AME 114 can identify a user of the client device 102 based on the device/user identifier 214 that the AME 114 receives from the client device 102. In some examples, the device/user identifier 214 may be encrypted (e.g., hashed) at the client device 102 so that only an intended final recipient of the device/user identifier 214 can decrypt the hashed identifier 214. For example, if the device/user identifier 214 is a cookie that is set in the client device 102 by the AME 114, the device/user identifier 214 can be hashed so that only the AME 114 can decrypt the device/user identifier 214. If the device/user identifier 214 is an IMEI number, the client device 102 can hash the device/user identifier 214 so that only a wireless carrier (e.g., the database proprietor 116) can decrypt the hashed identifier 214 to recover the IMEI for use in accessing information corresponding to the user of the client device 102. By hashing the device/user identifier 214, an intermediate party (e.g., an intermediate server or entity on the Internet) receiving the beacon request cannot directly identify a user of the client device 102.

In response to receiving the beacon/impression request 212, the AME impressions collector 218 logs an initial impression for the media 206 by storing the media identifier 213 contained in the beacon/impression request 212.

In some examples, the beacon/impression request 212 may not include the device/user identifier 214 if, for example, the user of the client device 102 is not an AME panelist. In some such examples, the AME impressions collector 218 logs the initial impressions regardless of whether the client device 102 provides the device/user identifier 214 in the beacon/impression request 212 (or in response to a request for the identifier 214). When the client device 102 does not provide the device/user identifier 214, the AME impressions collector 218 can still benefit from logging an initial impression for the media 206 even though it does not have corresponding demographics. For example, the AME 114 may still use the logged initial impression to generate a total impressions count for the media 206. The total impression count can be used by the example audience estimator 202 to estimate a total audience size as described below.

In the illustrated example of FIG. 2, to estimate a total audience size of the AME 114 with one or more database proprietors (e.g., the database proprietor 116), the AME impressions collector 218 returns an example beacon response message 222 (e.g., a first beacon response) to the client device 102 including an HTTP “302 Found” re-direct message and a URL of a participating database proprietor 116 at, for example, a second Internet domain. In the illustrated example, the HTTP “302 Found” re-direct message in the beacon response 222 instructs the client device 102 to send an example second beacon request 226 to the database proprietor 116. In some examples, instead of using an HTTP “302 Found” re-direct message, redirects may be implemented using, for example, an iframe source instruction (e.g., <iframe src=“ ”>) or any other instruction that can instruct a client device to send a subsequent beacon request (e.g., the second beacon request 226) to a participating database proprietor 116. In the illustrated example, the AME impressions collector 218 determines the database proprietor 116 specified in the beacon response 222 using a rule and/or any other suitable type of selection criteria or process. In some examples, the AME impressions collector 218 determines a particular database proprietor to which to redirect a beacon request based on, for example, empirical data indicative of which database proprietor is most likely to have demographic data for a user corresponding to the device/user identifier 214. In some examples, the beacon instructions 208 include a predefined URL of one or more database proprietors to which the client device 102 should send follow up beacon requests 226. In other examples, the same database proprietor is always identified in the first redirect message (e.g., the beacon response 222).

In the illustrated example of FIG. 2, the beacon/impression request 226 may include an example device/user identifier 227 that is a DP ID because it is used by the database proprietor 116 to identify a subscriber of the client device 102 when logging/recording a demographic impression. In some instances (e.g., in which the database proprietor 116 has not yet set a DP ID in the client device 102), the beacon/impression request 226 does not include the device/user identifier 227. In some examples, the DP ID is not sent until the database proprietor 116 requests the same (e.g., in response to the beacon/impression request 226). In some examples, the device/user identifier 227 is a device identifier (e.g., an IMEI, a MEID, a MAC address, etc.), a web browser unique identifier (e.g., a cookie), a user identifier (e.g., a user name, a login ID, etc.), an Adobe Flash® client identifier, identification information stored in an HTMLS datastore, and/or any other identifier that the database proprietor 116 stores in association with demographic information about subscribers corresponding to the client devices 102.

When the database proprietor 116 receives the device/user identifier 227, the database proprietor 116 can obtain demographic information corresponding to a user of the client device 102 based on the device/user identifier 227 that the database proprietor 116 receives from the client device 102. In some examples, the device/user identifier 227 may be encrypted (e.g., hashed) at the client device 102 so that only an intended final recipient of the device/user identifier 227 can decrypt the hashed identifier 227. For example, if the device/user identifier 227 is a cookie that is set in the client device 102 by the database proprietor 116, the device/user identifier 227 can be hashed so that only the database proprietor 116 can decrypt the device/user identifier 227. If the device/user identifier 227 is an IMEI number, the client device 102 can hash the device/user identifier 227 so that only a wireless carrier (e.g., the database proprietor 116) can decrypt the hashed identifier 227 to recover the IMEI for use in accessing demographic information corresponding to the user of the client device 102. By hashing the device/user identifier 227, an intermediate party (e.g., an intermediate server or entity on the Internet) receiving the beacon request cannot directly identify a user of the client device 102. For example, if the intended final recipient of the device/user identifier 227 is the database proprietor 116, the AME 114 cannot recover identifier information when the device/user identifier 227 is hashed by the client device 102 for decrypting only by the intended database proprietor 116.

Although only a single database proprietor 116 is shown in FIGS. 1 and 2, the impression reporting/collection process of FIGS. 1 and 2 may be implemented using multiple database proprietors. In some such examples, the beacon instructions 208 cause the client device 102 to send beacon/impression requests 226 to numerous database proprietors. For example, the beacon instructions 208 may cause the client device 102 to send the beacon/impression requests 226 to the numerous database proprietors in parallel or in daisy chain fashion. In some such examples, the beacon instructions 208 cause the client device 102 to stop sending beacon/impression requests 226 to database proprietors once a database proprietor has recognized the client device 102. In other examples, the beacon instructions 208 cause the client device 102 to send beacon/impression requests 226 to database proprietors so that multiple database proprietors can recognize the client device 102 and log a corresponding demographic impression. In some examples, multiple database proprietors are provided the opportunity to log demographic impressions and provide corresponding demographics information if the user of the client device 102 is a subscriber of services of those database proprietors.

In some examples, prior to sending the beacon response 222 to the client device 102, the AME impressions collector 218 replaces site IDs (e.g., URLs) of media provider(s) that served the media 206 with modified site IDs (e.g., substitute site IDs) which are discernable only by the AME 114 to identify the media provider(s). In some examples, the AME impressions collector 218 may also replace a host website ID (e.g., www.acme.com) with a modified host site ID (e.g., a substitute host site ID) which is discernable only by the AME 114 as corresponding to the host website via which the media 206 is presented. In some examples, the AME impressions collector 218 also replaces the media identifier 213 with a modified media identifier 213 corresponding to the media 206. In this way, the media provider of the media 206, the host website that presents the media 206, and/or the media identifier 213 are obscured from the database proprietor 116, but the database proprietor 116 can still log demographic impressions based on the modified values which can later be deciphered by the AME 114 after the AME 114 receives logged demographic impressions from the database proprietor 116. In some examples, the AME impressions collector 218 does not send site IDs, host site IDS, the media identifier 213 or modified versions thereof in the beacon response 222. In such examples, the client device 102 provides the original, non-modified versions of the media identifier 213, site IDs, host IDs, etc. to the database proprietor 116.

In the illustrated example, the AME impression collector 218 maintains a modified ID mapping table 228 that maps original site IDs with modified (or substitute) site IDs, maps original host site IDs with modified host site IDs, and/or maps modified media identifiers to the media identifiers, such as the media identifier 213, to obfuscate or hide such information from database proprietors such as the database proprietor 116. Also in the illustrated example, the AME impressions collector 218 encrypts some or all of the information received in the beacon/impression request 212 and the modified information to prevent any intercepting parties from decoding the information. The AME impressions collector 218 of the illustrated example sends the encrypted information in the beacon response 222 to the client device 102 so that the client device 102 can send the encrypted information to the database proprietor 116 in the beacon/impression request 226. In the illustrated example, the AME impressions collector 218 uses an encryption that can be decrypted by the database proprietor 116 site specified in the HTTP “302 Found” re-direct message.

Periodically or aperiodically, the demographic impression data collected by the database proprietor 116 is provided to an example DP impressions collector 232 of the AME 114 as, for example, batch data. As discussed above, the client devices 102d, 102e of FIG. 1 do not have DP IDs that the database proprietor 116 can use to identify demographics for users of those client devices 102. During a data collecting and merging process to combine initial impression data from the AME 114 and demographic impression data from the database proprietor(s) 116, initial impressions logged by the AME 114 for the client devices 102d, 102e will not correspond to demographic impressions logged/recorded by the database proprietor 116 because the database proprietor 116 does not log demographic impressions for the client devices 102d, 102e that do not have DP IDs.

In the example of FIG. 2, the AME 114 includes the example audience estimator 202 to estimate the size of an unknown audience. The unknown audience size k is estimated using a total number of initial impressions n for an online media, a number of demographic impressions R that were recorded by one or more database proprietors for the online media, a frequency distribution of the recorded demographic impressions, and a number of unique users A that the database proprietors recorded as observing the media. The total number of initial impressions n are modeled as being distributed among the unknown audience k via a Dirichlet-Multinomial Distribution model. The distribution of demographic impressions across the partial audience of the database proprietors is modeled via a Beta-Binomial distribution mixed with a Dirichlet-Multinomial, which has a Beta-Binomial as a marginal. Based on the modeled distribution of initial impressions and the modeled allocation of recorded demographic impressions, the audience estimator 202 estimates of the number of unknown people (k) who viewed the media campaign. In some examples, the estimate is assigned/used as the actual audience size.

The audience estimator 202 of the illustrated example is provided with an example impression allocator 234, an example impression modeler 236, and an example estimate determiner 238.

The example audience estimator 202 of FIG. 2 estimates an unknown audience size k corresponding to a total number of initial impressions n for an online media, based on modeling the distribution of the total initial impressions n among the unknown number of people k via a Dirichlet-Multinomial Distribution. The example impression allocator 234 of FIG. 2 is provided to allocate the total initial impressions n among the unknown number of people k via the Dirichlet-Multinomial Distribution model. This is done by assigning initial impressions to people according to a multinomial distribution, with a Dirichlet distribution as a mixture, which can be represented mathematically by the compound distribution of equation (1), which is:

$$Multinomial ( n ; {p}_{1} , … , {p}_{k} ) {⋀}_{{p}_{1} , … , {p}_{k}} Dirichlet ( {α}_{1} , … , {α}_{k} ) \qquad ( 1 )$$

In equation (1), n is the total number of initial impressions, pᵢ is the probability assigning a random initial impression to the i'th person, k is the unknown number of people and the set of αᵢ are the parameters for the Dirichlet-Multinomial distribution. The probability mass function of this compound distribution of equation (1) is given by equation (2), which is:

$$\begin{matrix}P ( {n}_{1} , … , {n}_{k} ) = \frac{n !}{{\prod }_{i = 1}^{k} {n}_{i} !} E [ {\prod }_{i = 1}^{k} {p}_{i}^{{n}_{i}} ] \\ = \frac{n ! Γ ( {\sum }_{i = 1}^{k} {α}_{i} )}{\{ {\prod }_{i = 1}^{k} {n}_{i} ! \} Γ ( n + {\sum }_{i = 1}^{k} {α}_{i} )} {\prod }_{i = 1}^{k} \{ \frac{Γ ( {n}_{i} + {α}_{i} )}{Γ ( {α}_{i} )} \} \\ = \frac{n !}{{( {\sum }_{i = 1}^{k} {α}_{i} )}^{[ n ]}} {\prod }_{i = 1}^{k} \{ \frac{{α}_{i}^{[ {n}_{i} ]}}{{n}_{i} !} \}\end{matrix} \\ {n}_{i} \geq 0 {\sum }_{i = 1}^{k} {n}_{i} = n \qquad ( 2 )$$

Equation (2) represents the probability of seeing exactly (n₁, n₂, . . . , nₖ) initial impressions distributed among respective one of k people (e.g. the first person having n₁ initial impressions, the second person having n₂ initial impressions, and so on, up to the k^{th} person having nₖ initial impressions). Equations (1) and (2) model the general allocation of n initial impressions across k people, where each person may be characterized differently. This model permits each person to be modeled with different probabilities of having initial impressions. More specifically, the model assigns an order to the people (e.g. Jim is #1, Richard is #2, Leslie is #3, etc.). If the order in which the people were assigned was known, each person could have their own distribution. However, because everyone is grouped together, any permutation is as likely as any other permutation. Therefore a single alpha is used. For the distribution of equation (2), the marginal distribution of nᵢ, which is the number of initial impressions for the ith person, is given by equation (3), which is:

$$Binomial ( n , {p}_{i} ) {⋀}_{{p}_{i}} Beta ( {α}_{i} , {α}_{•} - {α}_{i} ) \qquad ( 3 )$$

Equation (3) corresponds to the Beta-Binomial distribution with parameters (n,αᵢ,α_{•}−αᵢ) and has a probability mass function given by equation (4), which is:

$$\begin{matrix}Pr [ {N}_{i} = x ] = ( \begin{matrix}n \\ x\end{matrix} ) \frac{1}{Beta ( {α}_{i} , {α}_{•} - {α}_{i} )} {\int }_{0}^{1} {{p}_{i}^{x + {α}_{i} - 1} ( 1 - {p}_{i} )}^{n - x + {α}_{•} - {α}_{i} - 1} d {p}_{i} \\ = ( \begin{matrix}n \\ x\end{matrix} ) \frac{Γ ( {α}_{•} )}{Γ ( {α}_{i} ) Γ ( {α}_{•} - {α}_{i} )} \frac{Γ ( x + {α}_{i} ) Γ ( n - x + {α}_{•} - {α}_{i} )}{Γ ( n + {α}_{•} )} \\ = ( \begin{matrix}x + {α}_{i} - 1 \\ x\end{matrix} ) ( \begin{matrix}n - x + {α}_{•} - {α}_{i} - 1 \\ n - x\end{matrix} ) \text{/} ( \begin{matrix}n + {α}_{•} - 1 \\ n\end{matrix} )\end{matrix} \\ where {α}_{•} = {\sum }_{i = 1}^{k} {α}_{i} \qquad ( 4 )$$

Equation 3 and 4 give the marginal distribution of any specific person. For example, evaluating equation (4) for Pr[N₁₀=13] give the probability of the 10^{th} person seeing 13 initial impressions. If we assume αᵢ= . . . =αₖ=a, (as all permutations are equally likely, so no one person has a specific order) where a is now referred to as the concentration parameter, then equations (2) and (4) simplify to equations (5) and (6), which are:

$$\begin{matrix}P ( {n}_{1} , … , {n}_{k} ) = \frac{n ! Γ ( ak )}{Γ ( n + ak ) {( Γ ( a ) )}^{k}} {\prod }_{i = 1}^{k} \{ \frac{Γ ( {n}_{i} + a )}{{n}_{i} !} \} \\ {n}_{i} \geq 0 {\sum }_{i = 1}^{k} {n}_{i} = n \\ and & ( 5 ) \\ Pr [ {n}_{i} = x ] = BetaBinomial ( n , a , a ( k - 1 ) ) & ( 6 )\end{matrix}$$

Furthermore, from equations (5) and (6), the average number of impressions, nᵢ, for the i^{th} individual is given by equation (7), which is:

$$E [ n ] = \frac{an}{a + a ( k - 1 )} = \frac{n}{k} \qquad ( 7 )$$

With the forgoing assumption, the marginal distribution of allocating impressions to each person follows a Beta-Binomial distribution with only one unknown parameter, a (assuming the unknown audience size k is fixed, and the number of impressions n is known). As shown in equation (7), the expected value is the total number of initial impressions divided by the total number of people. By assuming a one parameter Dirichlet (e.g. setting αᵢ= . . . =αₖ=a in equations (3) and (4)), this makes each person ‘symmetric’, or, in other words there is no set ordering of people as all permutations are equally likely. Therefore, the assumption can't be made that any one person is assigned to a specific index (e.g. they are symmetric and all αᵢ are equal to a). The general case, described by equation (3), can assume some one individual may be more or less likely to be associated with initial media impressions than other people. Equation (7) can be used for a person, as any statistical property of that person is the same for any other person. This is the unknown truth of how many initial impressions each person actually saw, probabilistically.

The example audience estimator 202 of FIG. 2 also models the allocation of recorded demographic impressions across the partial audience by the database proprietors via a Beta-Binomial Distribution. In the illustrated example, the example impression modeler 234 models the allocation of recorded demographic impressions across the partial audience of the database proprietors via the Beta-Binomial Distribution.

As each person in the total (but unknown) audience k has to have at least one initial impression (otherwise they would not be in the audience), there are n−k remaining initial impressions to be distribution across the k people. The remaining n−k initial impressions can be distributed is some fashion, which as explained above is assumed to be governed by the Beta Binomial distribution. The number of demographic impressions a given database proprietor recorded (e.g. the recorded demographic impressions) is modeled by another Beta Binomial distribution, but the input of this is the output of the previous step. If 10 initial impressions are allocated to the person, then that output of 10 initial impressions will be input to the question ‘how many within the 10 initial impressions did the database proprietor record?’ which is modeled as another Beta Binomial distribution. Defining n′=n−k, the process is as follows:

1. Distribute n initial impressions across k people according to the Dirichlet-Multinomial distribution model of equation (3).

2. Add one extra initial impression to each person, guaranteeing each person in the audience of k people has at least one initial impression.

3. The model for the number of initial impressions for each person now follows a (shifted) Beta Binomial distribution.

4. Let the model for the probability of a demographic impression being recorded by the database proprietor for an individual follow a Beta Binomial Distribution with parameters (α,β).

5. This implies that, given the number of initial impressions seen by a person, the number of recorded demographic impressions would again be a Beta Binomial distribution.

6. Let Rᵢ be the number of demographic impressions recorded for each person after this procedure (e.g. the recorded demographic impressions).

The marginal distribution of the recorded demographic impressions Rᵢ is shown by equation (8), which is:

$${R}_{i} \text{:} BetaBinomial ( {n}_{i} , α , β ) {⋀}_{{n}_{i} - 1} BetaBinomial ( {n}^{′} , a , a ( k - 1 ) ) \qquad ( 8 )$$

The expected value of the number of recorded demographic impressions for an individual i follows directly from equation (9), which is:

$$\begin{matrix}E [ {R}_{i} ] = ( \frac{α}{α + β} ) ( 1 + \frac{{n}^{′}}{k} ) \\ = ( \frac{α}{α + β} ) \frac{n}{k}\end{matrix} \qquad ( 9 )$$

Equation 9 is stating that, if on average, some probability (for example 30%) of initial impression are recorded by the database proprietor (the (α/(α+β)) term), and on average each person saw some number (for example, 10) of initial impressions (the (n/k) term), then the database proprietor will record on average (α/(α+β))(n/k) of those initial impressions (e.g. 3 initial impressions in this example). Notice that if the total number of Recorded (R) demographic impressions across all people are known it would also equal the expected value of equation (9) multiplied by k. Dividing R by n yields the equality shown in equation (10), which is:

$$\frac{R}{n} = \frac{E [ {R}_{i} ] k}{n} = \frac{( \frac{α}{α + β} \frac{n}{k} ) k}{n} = \frac{α}{α + β} \qquad ( 10 )$$

which means that the proportion of recorded demographic impressions should equal the expected value of the Beta Binomial distribution of probability of being recorded. In other words, given that the number of recorded demographic impressions is known, what is the (α/(α+β) term. For example, if 60 demographic impressions were recorded from 100 initial impressions, then the (α/(α+13) term would equal 60/100=0.6 in order for the model to replicate what was observed (e.g. that 60% of the initial impressions were actually recorded).

One of the disadvantages of using the beta-binomial distribution is that it is not closed under addition. This can make using the joint distribution of the Dirichlet-Multinomial distribution, in combination of Beta-Binomial, for recorded demographic impressions, mathematically intractable as the probability of seeing r recorded demographic impressions out of n total initial impressions, with k people, depends on the actual distribution of initial impressions to begin with. The binomial distribution is closed so that the distribution of initial impressions does not matter, only the total amount

This can be overcome by making the following assumptions: (1) the number of initial impressions are quite large, (2) the number of subjects are quite large, (3) each person has negligible effect if removed from either the total number of initial impressions or total number of people. The benefit of those assumptions is the solution can be approximated by treating the marginal distribution for each individual as independent, and ignore the non-closure of the beta-binomial distribution in the calculations. The marginal distribution is solved for, and because independence is now assumed by negligible effects if removed, apply that same procedure to each person.

The solution is given in two parts; the first is the unconditional distribution of recorded demographic impressions across individuals, including the zero counts for some individuals. Finally, only those individuals with non-zero recorded demographic impressions were actually observed, so the conditional distribution (also known as the conditional probabilities) is computed for those individuals. The conditional distribution represents the people that the database proprietor actually recorded. The database proprietor did not record the impression some people saw. Because the database proprietor didn't register any of their impressions, they are unknown to database proprietor. This could be either that they are not registered with the database proprietor or that they are using an Internet café or some other non-typical access and never logged in to the database proprietor with that device.

Table 1 below yields possible combinations of recorded r demographic impressions (represented by an “x”) if there were actually m impressions for a given individual. Notice that the maximum number of demographic impressions allowed for any one person is n−k+1, while the minimum is 1. For recorded demographic impressions, zero is a valid number.

TABLE 1

| | r | | | | | | |
|---|---|---|---|---|---|---|---|
| m | 0 | 1 | 2 | 3 | 4 | . . . | n − k + 1 |
| 1 | x | x | | | | | |
| 2 | x | x | x | | | | |
| 3 | x | x | x | x | | | |
| 4 | x | x | x | x | x | | |
| 5 | x | x | x | x | x | | |
| . | | | | | | . | |
| . | | | | | | . | |
| . | | | | | | . | |
| n − k + 1 | x | x | x | x | x | . . . | x |

The probability that an individual has m initial impressions follows a beta-binomial distribution, shorthanded to BB, and is shown in equation (11), which is:

Pr[M=m]=BB(m−1;a,a(k−1),n−k) (11)

The probability that the database proprietor recorded r demographic impressions for an individual, given m initial impressions for the individual, also follows a beta-binomial distribution and is shown by equation (12), which is:

Pr[R=r|M=m]=BB(r;α,β,m)) (12)

Furthermore, the probability of having m initial impressions, and the database proprietor recoding r demographic impressions, is the product of the two probabilities (e.g. equations 11 and 12). The marginal distribution of just recorded demographic impressions, now designated as S, can be found by summing across all ways to get that number of recorded demographic impression as shown by equation (13), which is:

$$\begin{matrix}Pr [ S = s ] = {\sum }_{m = max \{ 1 , s \}}^{n - k + 1} Pr [ R = s \vert M = m ] Pr [ M = m ] \\ = {\sum }_{m = max \{ 1 , s \}}^{n - k + 1} BB ( s ; α , β , m ) BB ( m - 1 ; a , a ( k - 1 ) , n - k )\end{matrix} \qquad ( 13 )$$

Equation (13) is the unconditional probability of recording some number of (e.g. 0, 1, . . . ) demographic impressions for a given individual. The reason for the term max{1,s} in the summation index of equation (13) is that the lower bound should be one even if the number of recorded impressions for an individual is 0 (e.g. s=0), m is the number of demographic impressions seen by the individual and the individual is guaranteed, by being assumed to be in the audience, to have seen at least one recorded demographic impression. Examples of evaluating equation (13) for different possible numbers of recorded impressions are provided in equations (14) and (15). Equation (14) is:

$$\begin{matrix}Pr [ S = 0 ] = {A}_{1} {A}_{2} {A}_{3} {A}_{4} \\ {A}_{1} = \frac{β}{α + β} \\ {A}_{2} = \frac{Γ ( ak )}{Γ ( a ( k - 1 ) )} \\ {A}_{3} = \frac{Γ ( a ( k - 1 ) - k + n )}{Γ ( ( a - 1 ) k + n )} \\ {A}_{4} = {}_{3}^{}{F}{}_{2}^{} ( a , k - n , β + 1 ; - ka + a + k - n + 1 , α + β + 1 ; 1 )\end{matrix} \qquad ( 14 )$$

Equation 14 gives the probability that the database proprietor will completely miss a person (e.g. s=0). In the example of equation (14), none of that person's impressions were recorded by the database proprietor therefore the person is an unknown member of the audience (because this individual is assumed to be in the audience, but there are no recorded demographic impressions for this individual). In equation (14) and (15), F (Gamma) represents a Gamma function which is a generalization of the factorial function and only has one input. Equation (15) is the unconditional probability that the database proprietor recorded r of number of a person's initial impressions, which is:

$$\begin{matrix}Pr [ S = r ] = {B}_{1} ( {B}_{2} {B}_{3} - {B}_{4} {B}_{5} ) \\ {B}_{1} = \frac{Γ ( α + β ) Γ ( ak ) Γ ( a + s - 1 ) Γ ( - k + n + 1 ) Γ ( s + α ) Γ ( a ( k - 1 ) - k + n - s )}{Γ ( a ) Γ ( α ) Γ ( s + 1 ) Γ ( a ( k + 1 ) ) Γ ( ( a - 1 ) k + n ) Γ ( - k + n - s + 2 ) Γ ( s + α + β + 1 )} \\ {B}_{2} = r ( α + β + r ) ( ak - a - k + n - r ) \\ {B}_{3} = {}_{3}^{}{F}{}_{2}^{} ( a + r - 1 , k - n + r - 1 , β ; a ( - k ) + a + k - n + r , α + β + r ; 1 ) \\ {B}_{4} = β ( a + r - 1 ) ( k - n + r - 1 ) \\ {B}_{5} = {}_{3}^{}{F}{}_{2}^{} ( a + r , k - n + r , β + 1 ; a ( - k ) + a + k - n + r + 1 , α + β + r + 1 ; 1 )\end{matrix} \qquad ( 15 )$$

In equation (15), ₃F₂ represents a special case of the “Generalized Hypergeometric Function” pFq with p=3, q=2. The Generalized Hypergeometric Function is useful for simplifying complicated expressions in terms of a special cases; in this case with p=3 (with first three parameters given before the semicolon) and q=2 (last two parameters). In equation 15, the {a1,a2,a3} are given by expressions before the semicolon; the {β1, β2} after the semicolon, and the ‘1’ at the end represents that the function is being are evaluated at x=1. The conditional probability of observing a non-zero number r of demographic impressions from an individual is determined by combining equations (14) and (15), and is shown by equation (16), which is:

$$\begin{matrix}Pr \{ R = r ] = Pr [ S = r \vert r > 0 ] = \frac{Pr [ S = r ]}{1 - Pr [ S = 0 ]} & ( 16 ) \\ \begin{matrix}Pr [ R = r ] = \frac{{C}_{1} ( {C}_{2} {C}_{3} - {C}_{4} {C}_{5} )}{{C}_{6} ( {C}_{7} - {C}_{8} {C}_{9} )} \\ {C}_{1} = ( α + β ) Γ ( α + β ) Γ ( ak ) Γ ( a + r - 1 ) Γ ( - k + n + 1 ) Γ ( r + α ) Γ ( a ( k - 1 ) - k + n - r ) \\ {C}_{2} = r ( α + β + r ) ( a ( k - 1 ) - k + n - r ) \\ {C}_{3} = {}_{3}^{}{F}{}_{2}^{} ( a + r - 1 , k - n + r - 1 , β ; a ( - k ) + a + k - n + r , α + β + r ; 1 ) \\ {C}_{4} = β ( a + r - 1 ) ( k - n + r - 1 ) \\ {C}_{5} = {}_{3}^{}{F}{}_{2}^{} ( a + r , k - n + r , β + 1 ; a ( - k ) + a + k - n + r + 1 , α + β + r + 1 ; 1 ) \\ {C}_{6} = Γ ( a ) Γ ( α ) Γ ( r + 1 ) Γ ( - k + n - r + 2 ) Γ ( r + α + β + 1 ) \\ {C}_{7} = ( α + β ) Γ ( a ( k - 1 ) ) Γ ( ( a - 1 ) k + n ) \\ {C}_{8} = βΓ ( ak ) Γ ( a ( k - 1 ) - k + n ) \\ {C}_{9} = {}_{3}^{}{F}{}_{2}^{} ( a , k - n , β + 1 ; a ( - k ) + a + k - n + 1 , α + β + 1 ; 1 )\end{matrix} & ( 17 )\end{matrix}$$

Equation (17) is the probability of recording a non-zero number of impressions for an individual conditioned on the database proprietor having recorded at least one demographic impression for the individual and, thus, determined the individual is in the audience for the given media. In other words, equation (17) gives the probability of recording r demographic impressions for an individual given that database proprietor has at least one recorded demographic impression for the individual. This is the final distribution of recorded demographic impressions that the database proprietor actually sees on their end (given the models above). The impression modeler 234 uses equation (17) as the model for the probability of recording r demographic impressions for a person given that the person is associated with at least one demographic impression, which is based, as shown above, on a Beta-Binomial Distribution.

The example audience estimator 202 of FIG. 2 includes the example estimate determiner 236 to find an estimate of the number of people (k) who were exposed to media as part of the campaign, based on a total number of media impressions tagged by the AME (e.g. a total number of initial impressions) and the modeled number of recorded impressions across the partial audience. This is done by selecting a possible value for the number of people, k in the audience, evaluating the probability or likelihood of recording r demographic impressions for each individual (i) among the possible number of people k, and selecting the k that maximizes the likelihood of recording r demographic impressions for each individual (i) among the possible total number of people k. Note that the number of demographic impressions r recorded for different individuals (i) may be different.

The possible total number of people k is between a minimum number of people and a maximum number of people. The minimum number of people is equal to the number of people actually associated with recorded demographic impressions (also known as the partial audience A). The maximum number of people is equal to the total number of initial impressions n minus the sum of the number of recorded demographic impressions R plus the partial audience A (e.g. n−R+A). This maximum number assumes that each unknown (e.g. unobserved) person in the audience had only one initial impression. This is a mathematical fact, and can be proven, independent of any model. If the smallest unit is one impression, and no fractional impressions are allowed, then the unknown number of people k is between [A] and [n−R+A].

As explained above, the probability of recording r demographic impressions by the database proprietor, Pr[R=r], for a given individual is a function of several parameters listed in the table (2) below:

TABLE 2

| | Known or | |
|---|---|---|
| Notation | Parameter | Definition |
| α | Parameter | Beta-Binomial Parameter |
| β | Parameter | Beta-Binomial Parameter |
| k | Parameter | Unknown true number of people |
| a | Parameter | Concentration parameter of symmetric |
| | | Dirichlet distribution |
| r | Known | Number of recorded demographic |
| | | impressions for an individual |
| n | Known | Total number of initial impressions |
| R | Known | Total number of recorded demographic |
| | | impressions |
| A | Known | Partial audience size |

The likelihood function evaluated by the estimate determiner 238 assumes k is fixed but unknown and is in a range between [A] and [n−R+A]. In other words, in the likelihood function of equation 18, k is treated as a constant and not a variable parameter for a given estimation. To make that clear, a subscript k is used in the likelihood function of equation (18), which is:

$${L}_{k} ( θ ; {r}_{1} , … , {r}_{n} ) = Pr ( {r}_{1} , {r}_{2} , … , {r}_{A} \vert θ ) = {\prod }_{i = 1}^{A} Pr ( {r}_{i} \vert θ ) . \qquad ( 18 )$$

In equation (18) e is a vector of the parameters [α,β,a], with the other parameters of the table being fixed. For a given k, the estimate determiner 238 of the illustrated example determines the parameters [α,β,a], that yield the maximum value for Lₖ and then lets k vary from A to n−R+A. Stated mathematically, the audience estimator 238 determines the estimate audience size, k, according to equation (19), which is:

$$\hat{k} = {}^{*} {argmax}_{k} ( {L}_{k} ) \qquad ( 19 )$$

The audience estimator 236 further determines the parameters [α,β,a], using equation 20, which is:

$$\hat{θ} = {}^{*} {argmax}_{θ} ( {L}_{\hat{k}} ) \qquad ( 20 )$$

The example estimate determiner 236 evaluates equation 19 for each of the possible k's between [A] and [n−R+A] to give the likelihood for that k. The k that maximizes the likelihood is the best estimate. Equation 19 can be converted into a log-likelihood function when looking for the k that maximizes the likelihood. In some examples, instead of maximizing the log-likelihood, it may be computationally easier for the estimate determiner 238 to minimize the negative of the log-likelihood. In some examples, the estimate determined by the estimate determiner 238 is assigned/used by the AME 114 as the actual audience size.

Although the audience estimator 202 is shown as being located in the AME 114 in the example of FIG. 2, the audience estimator 202 may alternatively be located anywhere, including at the database proprietor 116, or at any other suitable location separate from the AME 114 and the database proprietor 116. Also, although the AME impression allocator 218, the modified ID map 228, and the DP impressions collector 232 are shown separate from the audience estimator 202, one or more of the AME impressions collector 218, the modified ID map 228, and the DP impressions collector 232 may be implemented in the audience estimator 202

To further illustrate the operation of the example audience estimator 202, consider the following example in which 833 initial impressions are logged by the AME impression collector 218 for a given media campaign, thus, the audience estimator 202 sets the total number of initial impressions to be 833. The 833 initial impressions are sent to the database proprietor 116. The database proprietor 116 returned the following demographic impression information for this campaign, which is received by the DB impression collector 232:

TABLE 3

| Recorded | Frequency |
|---|---|
| 1 | 31 |
| 2 | 22 |
| 3 | 8 |
| 4 | 7 |
| 5 | 3 |
| 6 | 3 |
| 7 | 1 |
| 8 | 2 |
| 9 | 1 |
| 10 | 3 |
| 11 | 1 |
| 12 | 2 |
| 14 | 1 |
| 15 | 1 |
| 20 | 1 |
| 46 | 1 |
| 49 | 1 |
| 77 | 1 |

The left hand column in table 3 is the number of demographic impressions recorded. The right hand column is the number of individuals for which those number of demographic impressions were recorded. For example, the second row indicates that 22 people had 2 recorded demographic impressions each. Table 3 further shows that 478 out of the 833 initial impressions were recorded, among 90 unique people (e.g. the sum of the righthand column equals 90, which is the partial audience size, A). The total number of demographic impressions recorded (R) is equal to the sum of the product of the number recorded times the frequency. For example, R=478=((1*31)+(2*22)+(3*8)+ . . . +(77*1)). As explained above, the total number of unknown people is bounded by a minimum of A=90 and a maximum of [n−R+A] 445 ([n−R+A]=833−478+90).

For a given unknown number of people k, equation (19) is evaluated by the estimate determiner 238, taking into account the constraint of equation (10). This is done for each possible value of k. Furthermore, the estimate determiner 238 invokes the impression modeler 236 to evaluate equations (16) and (17) for each member of the partial audience, which the estimate determiner 238 combines the result of each member according to equation (19). Then the estimate determiner 238 solves for a and a using equation (20) which maximizes the likelihood function of equation (19) and, thus, yields values of the unknown audience size k and parameters a and a for a BB model representing the distribution of demographic impressions across the partial audience size.

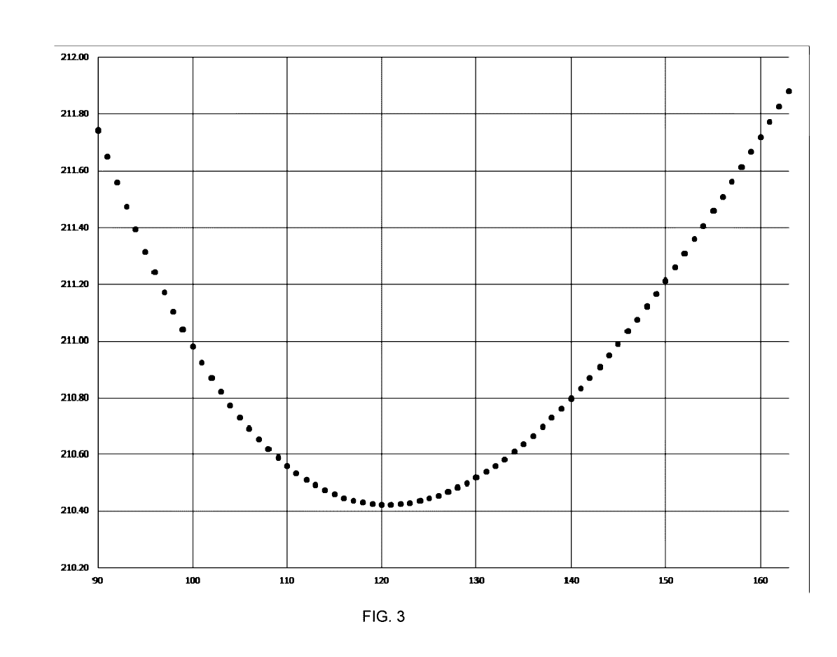

FIG. 3 is an example plot showing estimations of an unknown audience size. The horizontal axis is the value k. The vertical axis is the negative-log-likelihood of the BB model for the distribution of demographic impressions across partial audience members for each of the possible unknown audience sizes. The plot in FIG. 3 ends at 163 instead of 445 due to ease of illustration of the graph. The minimum occurs at \hat{k}=121. Therefore, in this example, 121 is the estimate of the actual number of unknown people. In this example, the actual number of people is known because panel data was used. The actual number of people yielding initial impressions was 125 people. In other words, in reality there were 125 people representing 833 initial impressions, of which 478 were recorded by a database proprietor as representing 90 unique users (out of the 125). Using the frequency distribution of the recorded number of demographic impressions and the total number of initial impressions, the method predicted an estimate of 121 people.

For completeness, the other variables evaluated by the estimate determiner 238 for this example at k=121 are:

| Variable | Value |
|---|---|
| \hat{k} | 121 |
| â | 0.357134435 |
| \hat{α} | 0.849074624 |
| \hat{β} | 0.630588894 |

Where \hat{k} is the best estimate for the total audience size, \hat{α} is the concentration parameter, and \hat{α} and \hat{β} are parameters of the Beta Binomial Distribution.

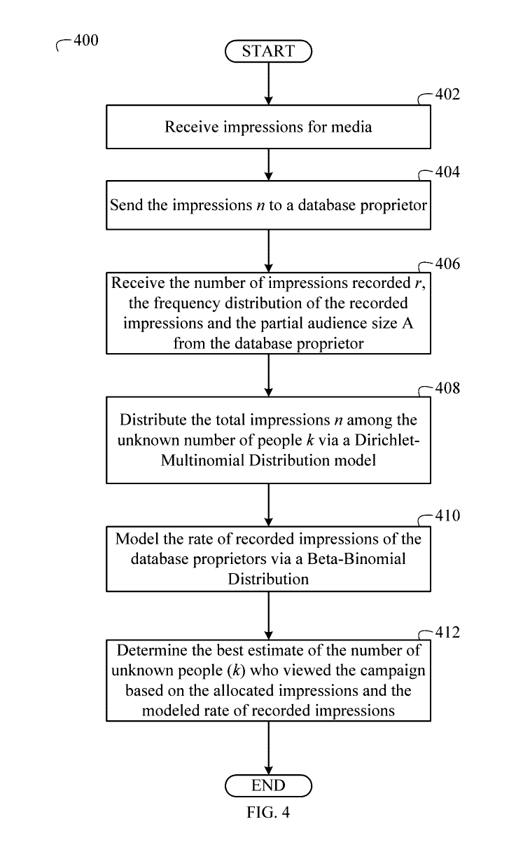

While an example manner of implementing the Audience measurement entity (AME) 114 of FIG. 1 is illustrated in FIG. 2, one or more of the elements, processes and/or devices illustrated in FIG. 2 may be combined, divided, re-arranged, omitted, eliminated and/or implemented in any other way. Further, the example audience estimator 202, the example AME impressions collector 218, the example modified ID map 228, the example DP impressions collector 232, the example impression allocator 234, the example impression modeler 236, and/or the example estimate determiner 238 and/or, more generally, the example AME 114 of FIG. 1 may be implemented by hardware, software, firmware and/or any combination of hardware, software and/or firmware. Thus, for example, any of the example audience estimator 202, the example AME impressions collector 218, the example modified ID map 228, the example DP impressions collector 232, the example impression allocator 234, the example impression modeler 236, and/or the example estimate determiner 238 and/or, more generally, the example AME 114 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, audience estimator 202, the example AME impressions collector 218, the example modified ID map 228, the example DP impressions collector 232, the example impression allocator 234, the example impression modeler 236, and/or the example estimate determiner 238 is/are hereby expressly defined to include a tangible computer readable storage device or storage disk such as a memory, a digital versatile disk (DVD), a compact disk (CD), a Blu-ray disk, etc. storing the software and/or firmware. Further still, the example AME 114 of FIG. 1 may include one or more elements, processes and/or devices in addition to, or instead of, those illustrated in FIG. 4, and/or may include more than one of any or all of the illustrated elements, processes and devices.

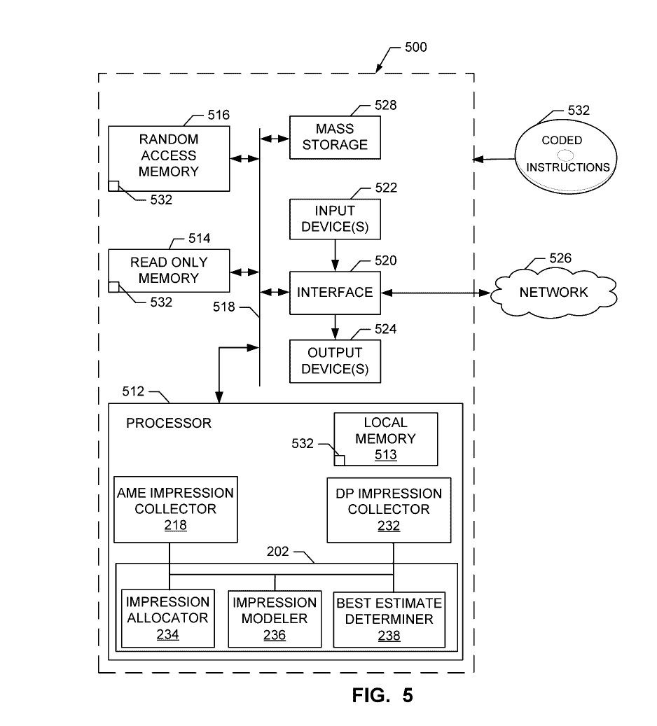

A flowchart representative of example machine readable instructions for implementing the AME 114 of FIGS. 1 & 2 is shown in FIG. 4. In this example, the machine readable instructions comprise a program for execution by a processor such as the processor 512 shown in the example processor platform 500 discussed below in connection with FIG. 5. The program may be embodied in software stored on a tangible computer readable storage medium such as a CD-ROM, a floppy disk, a hard drive, a digital versatile disk (DVD), a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowchart illustrated in FIG. 4, many other methods of implementing the example AME 114 of FIGS. 1 & 2 may alternatively be used. For example, the order of execution of the blocks may be changed, and/or some of the blocks described may be changed, eliminated, or combined.

As mentioned above, the example processes of FIG. 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Secondarily or alternatively, the example processes of FIG. 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 400 of FIG. 4 begins with the AME impressions collector 218 of FIG. 2 collecting initial impressions for online media (block 402). Flow continues at block 404.

The DP impressions collector 232 of FIG. 2 sends the collected initial impressions n from the AME impressions collector 218 to the database proprietor (DP) 116 (block 404). In the illustrated example, only one database proprietor (DP) 116 is shown. In other examples, there may be multiple database proprietors (DP). In some such examples, the DP impressions collector 232 sends the collected initial impressions from the AME impressions collector 218 to multiple database proprietors (DP). Flow continues at block 406.

The DP impressions collector 232 receives the number of demographic impressions recorded R, the frequency distribution of the recorded demographic impressions and the partial audience size A from the database proprietor (block 406) that correspond to the collected initial impressions n for the online media. In some examples, the DP impressions collector 232 receives the frequency distribution of the recorded demographic impressions from the database proprietor (block 406) that correspond to the collected initial impressions n for the online media. The number of demographic impressions recorded R and the partial audience size A are determined from the frequency distribution of the recorded demographic impressions. In some examples, the DP impressions collector 232 may receive this information from multiple database proprietors. Flow continues at block 408.

The impression allocator 234 of FIG. 2 distributes the total initial impressions n among the unknown number of people k via a Dirichlet-Multinomial Distribution model (block 408). The impression allocator 234 uses equation 8 to randomly assigns impressions to each person, but since n impressions have to be allocated to k people, the expected value per person is n/k. However, this does not mean each person receives exactly n/k impressions. In other words, the impression allocator is not allocating n/k for each person, but n impressions across k people. Flow continues at block 410.

The impression modeler 234 of FIG. 2 models the distribution of demographic impressions recorded for the partial audience members recognized by the database proprietors via a Beta-Binomial Distribution (block 410). The impression modeler 234 uses equation 20 as the model for the probability of recording r demographic impressions given that the person observed at least one demographic impression. Flow continues at block 412.

The estimate determiner 236 of FIG. 2 determines the estimate of the number of unknown people (k) who viewed the online media based on the modeled distribution of initial impressions and the modeled distribution of recorded demographic impressions (block 412). The estimate determiner 236 evaluates equation 20 for each of the possible k's between [A] and [n−R+A] to give the log-likelihood for that k. The k that maximizes the log-likelihood is the best estimate. Instead of maximizing the log-likelihood, in some examples, the estimate determiner 238 minimizes the negative of the log-likelihood. In some examples, the AME 114 assigns or otherwise uses the estimate as the actual audience size.

FIG. 5 is a block diagram of an example processor platform 500 capable of executing the instructions of FIG. 4 to implement the AME 114 of FIGS. 1 & 2. The processor platform 500 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer. In the illustrated example of FIG. 5, the processor 512 is configured via example instructions 532 to implement the example AME impression collector 218, the DP impression collector 232, the audience estimator 202, the impression allocator 234, the impression modeler 236 and the estimate determiner 238 of FIG. 2.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives.

The coded instructions 532 of FIG. 4 may be stored in the mass storage device 528, in the volatile memory 514, in the non-volatile memory 516, and/or on a removable tangible computer readable storage medium such as a CD or DVD.

From the foregoing, it will be appreciated that the above disclosed methods, apparatus and articles of manufacture to estimate an unknown audience size from recorded demographic impressions takes advantage of the large base of users registered with database proprietors. The disclosed methods, apparatus and articles of manufacture to estimate an unknown audience size from recorded demographic impressions can also take advantage of multiple database proprietors for the same online media. In addition, the disclosed methods, apparatus and articles of manufacture to estimate an unknown audience size from recorded demographic impressions is independent from the rate at which people report the initial impressions and the length of the media campaign. Furthermore, the disclosed methods, apparatus and articles of manufacture to estimate an unknown audience size from recorded demographic impressions do not require calibration like some prior methods.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method of estimating an unknown audience size from recorded demographic impressions for an online media, the method comprising:
accessing, for the online media, a total number of initial impressions and a frequency distribution of the recorded demographic impressions across a partial audience size;
determining, with a processor and based on the total number of initial impressions and the frequency distribution of the recorded demographic impressions across the partial audience, models modeling a probability of obtaining the frequency distribution of the recorded demographic impressions across the partial audience for different possible unknown audience sizes in a range of unknown audience sizes;
determining, with the processor, an estimate for the unknown audience size by evaluating the models for the different possible unknown audience sizes.

2. The method of claim 1, further including:
assigning the estimate as an actual audience size for the online media.

3. The method of claim 1, wherein the frequency distribution of the recorded demographic impressions across the partial audience is received from a database proprietor.

4. The method of claim 3, wherein the database proprietor includes at least one of a social network service provider, a multi-service service provider, a streaming media service provider, an online shopping service provider, or a credit reporting service provider.

5. The method of claim 3, wherein the frequency distribution of the recorded demographic impressions across the partial audience is received from the database proprietor in response to sending a list of the total number of initial impressions for the online media to the database proprietor.

6. The method of claim 1, wherein the models are based on Beta-Binomial Distributions.

7. The method of claim 1, wherein the total number of initial impressions are modeled as being distributed across a first possible unknown audience having a first possible unknown audience size via a Dirichlet-Multinomial Distribution.

8. The method of claim 7, wherein the Dirichlet-Multinomial Distribution is symmetric.

9. The method of claim 8, wherein the model of the Dirichlet-Multinomial Distribution is modified by adding one initial impression to each person in the unknown audience such that the number of initial impressions for each person follows a shifted Beta Binomial distribution.

10. The method of claim 1, wherein a probability of a demographic impression being recorded for an individual is modeled as a Beta Binomial Distribution.

11. The method of claim 1, wherein the determining of the estimate for the unknown audience size includes evaluating log-likelihood metrics for respective ones of the models using the frequency distribution of recorded demographic impressions across the partial audience, selecting one of the models based on the log-likelihood, and selecting a respective one of the possible unknown audience sizes corresponding to the selected model to be the estimate for the unknown audience size.

12. The method of claim 1, wherein the range of unknown audience sizes has a minimum value of a partial audience size and a maximum value of the total number of initial impressions minus a number of recorded demographic impressions plus the partial audience size.

13. The method of claim 1, further including:
determining the partial audience size and the number of recorded demographic impressions from the frequency distribution of the recorded demographic impressions.

14. An apparatus, comprising:
an impression modeler to determine models, based on a total number of initial impressions and a frequency distribution of recorded demographic impressions across a partial audience size, that model the probability of obtaining the frequency distribution of the recorded demographic impressions across the partial audience for different possible unknown audience sizes of an unknown audience exposed to online media;
a estimate determiner to determine an estimate a size od the unknown audience by evaluating the models for the different possible unknown audience size, across a range of unknown audience sizes.

15. The apparatus of claim 14, further comprising:
an audience measurement entity (AME) impressions collector to collect, for the online media, the total number of initial impression;
a database proprietor (DP) impressions collector to collect the frequency distribution of recorded demographic impressions across the partial audience;
an impressions allocator to allocate the total number of initial impressions among the unknown audience.

16. (canceled)

17. The apparatus of claim 14, wherein the frequency distribution of the recorded demographic impressions across the partial audience is received from a database proprietor.

18. The apparatus of claim 17, wherein the database proprietor includes at least one of a social network service provider, a multi-service service provider, a streaming media service provider, an online shopping service provider, or a credit reporting service provider.

19. (canceled)

20. The apparatus of claim 14, wherein the models are based on Beta-Binomial Distributions.

21. (canceled)

22. (canceled)

23. (canceled)

24. The apparatus of claim 14, wherein a probability of a demographic impression being recorded for an individual is modeled as a Beta Binomial Distribution.

25. The apparatus of claim 14, wherein the determining of the estimate for the unknown audience size includes evaluating log-likelihood metrics for respective ones of the models using the frequency distribution of recorded demographic impressions across the partial audience, selecting one of the models based on the log-likelihood, and selecting a respective one of the possible unknown audience sizes corresponding to the selected model to be the estimate for the unknown audience size.

26. The apparatus of claim 14, wherein the range of unknown audience sizes has a minimum value of a partial audience size and a maximum value of the total number of initial impressions minus a number of recorded demographic impressions plus the partial audience size.

27. (canceled)

28. A tangible computer readable medium comprising computer readable instructions which, when executed, cause a processor to at least:
access, for an online media, a total number of initial impressions and a frequency distribution of the recorded demographic impressions across a partial audience;
determine a partial audience size and a number of demographic impressions from the frequency distribution of the recorded demographic impressions;
determine models, based on the total number of initial impressions and the frequency distribution of the recorded demographic impressions across the partial audience size, modeling a probability of obtaining the frequency distribution of the recorded demographic impressions across the partial audience for different possible unknown audience sizes in a range of unknown audience sizes;
determine an estimate for the unknown audience size by evaluating the models for the different possible unknown audience sizes.

29. (canceled)

30. The storage medium as defined in claim 28, wherein the frequency distribution of the recorded demographic impressions across the partial audience is received from a database proprietor.

31. The storage medium as defined in claim 30, wherein the database proprietor includes at least one of a social network service provider, a multi-service service provider, a streaming media service provider, an online shopping service provider, or a credit reporting service provider.

32. (canceled)

33. The storage medium as defined in claim 28, wherein the models are based on Beta-Binomial Distributions.

34. The storage medium as defined in claim 28, wherein the total number of initial impressions are modeled as being distributed across the unknown audience via a Dirichlet-Multinomial Distribution.

35. The storage medium as defined in claim 34, wherein the Dirichlet-Multinomial Distribution is symmetric.

36. (canceled)

37. The storage medium as defined in claim 28, wherein a probability of a demographic impression being recorded for an individual is modeled as a Beta Binomial Distribution.

38. The storage medium as defined in claim 28, wherein the estimate for the unknown audience size is determined by evaluating log-likelihood metrics for respective ones of the models, using the frequency distribution of recorded demographic impressions across the partial audience, selecting one of the models based on the log-likelihood metrics, and selecting a respective one of the possible unknown audience sizes corresponding to the selected model to be the estimate for the unknown audience size.

39.-40. (canceled)
